(19) United States
(12) Patent Application Publication
(10) Pub. No.: US 2013/0288172 A1
(43) Pub. Date: Oct. 31, 2013

(54) ELECTROPHOTOGRAPHIC TONER COMPRISING A HIGH-MELTING WAX, A PRINTING SYSTEM FOR APPLYING SAID TONER ON AN IMAGE RECEIVING MEDIUM AND A METHOD FOR PREPARING SAID TONER

(71) Applicant: OCE TECHNOLOGIES B.V., Venlo (NL)

(72) Inventors: Roelof H. EVERHARDUS, Lomm (NL); Michael T. J. VERHEGGEN, Weert (NL); Henricus P. M. TIMMERMANS, Kessel (NL)

(21) Appl. No.: 13/930,828

(22) Filed: Jun. 28, 2013

Related U.S. Application Data
(63) Continuation of application No. PCT/EP2012/050167, filed on Jan. 6, 2012.

(30) Foreign Application Priority Data
Jan. 12, 2011 (EP) 11150707.5

(51) Int. Cl. G03G 9/00; G03G 15/08

(52) U.S. Cl. CPC G03G 9/08755; G03G 15/16; G03G 9/081
USPC 430/105; 430/108.8; 430/137.21; 399/252

(57) ABSTRACT

The invention relates to a toner for developing a toner image, the toner comprising a binder resin, an inorganic component and a wax. The wax is finely dispersed within the toner and has a melting transition, wherein the lower temperature limit of the melting transition is between 110° C. and 140° C. at the time of temperature rise in the DSC curve measured using a differential scanning calorimeter.

The invention further relates to a printing system for applying the toner according to the present invention on an image receiving medium. The invention further relates to a method for preparing the toner according to the present invention.

### FIELD OF INVENTION

The invention relates to a toner comprising a high-melting wax for improving robustness of a toner image provided by a printing process of the toner. The invention also relates to a method for producing the toner comprising the high-melting wax. The invention also relates to a printing system using the toner comprising the high-melting wax.

### BACKGROUND

In toner based printing systems wherein the toner is transferred to an image receiving means and fixed by pressure and temperature, the robustness of the toner images on the image receiving means is restricted by the scratch and smear resistance of the binders of the toner. Especially for finishing processes of printed toner images, e.g. collecting and binding of several image receiving means, the robustness of the image is of importance.

In general waxes are known to be able to improve the robustness of the printed images. In particular for toner images the Coefficient of Friction of the toner image can be decreased by proper distribution of the wax in the toner. As a result the robustness of the toner image is improved. The improvement of the robustness of the toner image is in particular provided during the fixing process of the toner onto the image receiving medium, wherein the wax in the toner is at least partly melted and transported to the surface of the toner image.

Commonly waxes are selected for application in toner imaging systems, which have a low melting temperature range, typically in a temperature range starting below 110° C., in order that the wax is at least partly molten during the fixing process of the toner on the image receiving medium at elevated temperature and the energy consumption of the fixing process is minimised. On the other hand the waxes are selected such that the melting temperature is above 50° C. in order that the wax does not impart the developing performance of the toner in the image developing process at a temperature between room temperature and 50° C.

In toner based printing systems, wherein the transfer of the toner between the developing means and the image receiving medium is provided by an intermediate image bearing means, durability of the developing performance of the printing system has been shown to be more critical to the use of toners comprising a wax component. Commonly applied waxes for reducing the Coefficient of Friction and enhancing the robustness of the toner image have shown to contaminate the developing means in long-term of a printing system comprising an intermediate image bearing means, such that parts of the printing system have to be cleaned and/or exchanged at a high rate. Furthermore often the dispersability of polyolefin waxes in toner is improved by adding a small amount of wax compatibilizer to the polyolefin waxes. However the use of wax compatibilizer in toner also have shown to contaminate the developing means in long-term of a printing system comprising an intermediate image bearing means, such that parts of the printing system have to be cleaned and/or exchanged at a high rate.

### Technical Problem

As described above, a disadvantage of toners comprising a wax for improving robustness of toner images is the conflicting properties of Coefficient of Friction, long-term developing performance of the printing system, fixing performance and dispersability of the wax in the toner. This may result in contamination of the developing means of a printing system in long-term, such that parts of the printing system have to be cleaned and/or exchanged at a high rate.

### Object

It is an object to provide a toner for improving the robustness of the toner image, while ensuring long-term developing performance of the toner in the printing system. It is a further object of the invention to ensure proper fixing performance of the toner on the image receiving medium.

It is a further object of the present invention to provide a toner wherein a wax is uniformly dispersed in the toner by means of conventional mechanical toner production methods, while ensuring long-term developing performance of the toner in the printing system and proper fixing performance of the toner on the image receiving medium.

It is a further object of the present invention to provide a toner comprising a wax which provides a satisfactory temperature range of the transfer process of the toner from an intermediate image bearing means to an image receiving medium. Preferably, the temperature range of the transfer process of the toner from an intermediate image bearing means to an image receiving medium, provided by the toner, should be broad enough to allow on the one hand the toner to be successfully transferred and to allow the temperature to show a small variation, as is known in the art and on the other hand to prevent the printing system to be contaminated by the toner comprising a wax.

### Solution

According to the invention, this object is achieved by a toner for developing a toner image, the toner comprising:

(i) a binder resin, (ii) an inorganic component, preferably a magnetic component, and (iii) a wax, finely dispersed in the binder resin, the wax having a wax melting transition, wherein the lower temperature limit of said wax melting transition is between 110° C. and 140° C. at the time of temperature rise in the DSC thermogram measured using a differential scanning calorimeter. Said wax melting transition at the time of temperature rise in the DSC thermogram was measured at a heating rate of 10° C./min at the time of rise according to the ASTM D3418 Standard using a differential scanning calorimeter. Throughout the application, the “lower temperature limit of a wax melting transition at the time of temperature rise” should be interpreted as “the temperature at which at most 10 wt % of the solid wax is molten, when measured at the time of temperature rise in the DSC thermogram, at a heating rate of 10° C./min according to the ASTM D3418 Standard using a TA Instruments Q2000 differential scanning calorimeter”, unless stated otherwise.

### Advantage

The toner of the present invention comprises at least one binder resin, an inorganic component and at least one wax. The toner of the present invention provides the advantage that the Coefficient of Friction of the toner image, the long-term contamination of the printing system, the fixing performance of the toner image, and the dispersability of the wax in the toner, some of which conflict each other, could be improved by using a wax having a high-melting transition temperature range, more preferably a sharp-melting transition within this melting range. In the context of the present invention, high-melting transition temperature range means that the melting transition temperature range is higher than the temperature at which the toner image is fixed onto the image receiving member. In case an intermediate image bearing means is used and the toner imaged is transferred from the intermediate image bearing means to the image receiving member in a transfuse step, a high-melting transition temperature range means that the melting transition temperature range is higher than the temperature at which the toner image is transfused onto the image receiving member. In the context of the present invention, a sharp-melting transition within the melting transition temperature range means that the melting transition temperature range is relatively narrow. For example, the melting transition temperature range may be 30° C. or less. In an alternative embodiment, the melting transition temperature range may be 20° C. or less.

The high-melting wax has a melting transition, wherein the lower temperature limit of said wax melting transition is in a temperature range of 110° C. to 140° C. Preferably, the lower temperature limit of the high-melting wax melting transition is in a temperature range of 115° C. to 130° C. More preferably, the lower temperature limit of the high-melting wax melting transition is in a temperature range of 120° C. to 125° C. In a known printing system, the toner may be fixed onto an image receiving medium at a fixing temperature of 90° C.-110° C. The term fixing as used herein may also comprise transfusing. Using toner comprising said high-melting wax no long-term contamination of the printing system or deterioration on the developing performance of the toner has been observed. If the melting transition of the wax starts lower than 110° C., the durability of the development performance decreases. Thus the lower limit temperature of said wax melting transition according to the present invention is at least 110° C. or higher.

Herein the lower limit temperature of a melting transition is defined as being the temperature at which at most 10% fraction of the solid wax is molten, when measured at a heating rate of 10° C./min at the time of temperature rise according to the ASTM D3418 Standard using a TA Instruments Q2000 differential scanning calorimeter. In a preferred embodiment the melted fraction of the wax at 110° C. is at most 5% of the wax, when measured under the same conditions.

The wax is finely dispersed in the binder resin. The advantage of the finely dispersed wax in the toner is that the Coefficient of Friction of the toner image is low without the need for melting the wax during a fixing process. As a result the toner image may be fixed onto an image receiving medium at a fixing temperature of 90° C.-110° C. If the lower limit temperature of the melting transition of the wax is higher than 140° C., the melting transition range becomes excessively high to make it hard to achieve a good dispersability of the wax in the toner and to achieve a satisfactory fixing performance of the toner. In case the wax is not finely dispersed in the binder resin the toner production yield is reduced. The coarse wax domains in the toner particles are fragile. As a result the toner particles easily break up at the position of the coarse wax domains in the toner particles during the conventional production processes (e.g. classification steps) of toner particles.

In addition, to prepare a toner according to an embodiment of the present invention, the wax may have a narrow wax melting transition, having an upper temperature limit of at most 145° C., measured using a differential scanning calorimeter, wherein the wax melting transition at the time of temperature rise in the DSC thermogram was measured at a heating rate of 10° C./min according to the ASTM D3418 Standard using a TA Instruments Q2000 differential scanning calorimeter. Herein the upper limit temperature of a melting transition is defined as being the temperature at which at least 90% fraction of the solid wax is molten, when measured at a heating rate of 10° C./min at the time of temperature rise according to the ASTM D3418 Standard using a TA Instruments Q2000 differential scanning calorimeter. Said narrow wax melting transition range is in between 110° C., the lower limit temperature, and 145° C., the upper limit temperature. The narrow melting transition of the wax in a temperature range of 110° C. to 145° C. provides the advantage that the wax can be dispersed in the binder resin of the toner in a mechanical mixing process at a temperature close to a peak temperature in the melting transition range of the wax. As a result the wax may be finely dispersed in the binder resin of the toner in a conventional mechanical mixing process. The finely dispersed wax enhances fast migration of the wax to the surface of the toner image during the fixing process. In a preferred embodiment, the wax may have a narrow wax melting transition, having an upper temperature limit of at most 140° C. In a more preferred embodiment, the wax may have a narrow wax melting transition, having an upper temperature limit of at most 135° C.

The toner comprising the narrow melting wax may be fixed onto an image receiving medium at a temperature similar or close to a fixing temperature of a regular toner without a wax, while providing a low Coefficient of Friction of the toner image. The Coefficient of Friction of the toner image may be further reduced in the fixing process.

The toner of the present invention provides improved print robustness, which is adequate for the finishing processes of the printed toner images.

The toner of the present invention may be prepared by conventional mechanical processes. The conventional method of preparing a toner powder is to mix the constituents in the melt, cool the melt, and then grind and classify it to the correct particle size. The toner comprising the wax is adapted to grinding and satisfies requirements in respect of toughness and brittleness.

In addition, to prepare a toner according to another embodiment of the present invention, the wax may be an oxidized polyalkylene wax. The use of polyalkylene waxes, such as polyethylene, polypropylene, or combinations thereof, is commonly known. Polyalkylene waxes are apolar and the compatibility of these waxes with medium polar binder resins, such as polyesters, polyamides, polyurethanes, is mediocre. Moreover, the compatibility of apolar waxes with inorganic components, such as metal oxides, may be weak. The addition of a wax compatibilizer may be used to provide a fine dispersion of an polyalkylene wax in the toner matrix, the toner matrix comprising the binder resin and the inorganic component. However, it has been found that a wax compatibilizer also may lead to long-term contamination of the development means.

Oxidized polyethylene waxes are more polar and, as such, the compatibility of the wax in the binder resin is enhanced without the addition of a wax compatibilizer to the toner composition. As a result the finely dispersed oxidized wax in the toner provides a good durability for the development means of the printing system. An oxidized polyalkylene wax may comprise a polar endgroup, such as a carboxylic acid group. The polar endgroups may interact with the matrix of the toner, the matrix of the toner comprising a binder resin and an inorganic component, preferably a magnetic component. Because of the interaction between the end groups of the wax and the matrix, the wax is more strongly retained within the matrix.

Thus, there are at least two mechanism that prevent the wax from escaping the toner matrix. In the first place, the toner does not, or only to a small extend, melt at a temperature below the lower temperature limit of the wax melting transition. The wax may be better retained in the toner matrix when the wax is not molten. Secondly, the wax has a interaction with the toner matrix, such that the wax is retained in the toner matrix. As a consequence, contamination of the developing means of a printing system may be prevented efficiently by the toner according to the present invention.

In an embodiment, to prepare the toner of the present invention, the wax melting transition in the toner has an endothermic enthalpy at the time of temperature rise in the DSC curve measured using a differential scanning calorimeter, which is substantially 100% of the total endothermic enthalpy of the wax melting transition in the toner in the temperature range 50° C. to 180° C. at the time of temperature rise in the DSC curve measured at a heating rate of 10° C./min according to the ASTM D3418 Standard using a TA Instruments Q2000 differential scanning calorimeter.

The total endothermic enthalpy of the wax in the toner at the time of temperature rise in the DSC curve is measured between 50° C. and 180° C. According to this embodiment the whole melting range of the wax when dispersed in the toner is important. In case the endothermic enthalpy of melting in the wax melting transition, having a lower temperature limit of at least 110° C. or higher, is substantially 100% of the total endothermic enthalpy of the wax in the toner in the temperature range between 50° C. and 180° C., the toner provides a durable long-term development performance in the printing system.

The toner comprises at least one binder resin, for example a thermoplastic polymer or a pressure-sensitive polymer. Common binder resins are styrene polymers, styrene copolymers such as styrene acrylates, styrene-butadiene copolymers and styrene maleic acid copolymers, cellulose resins, polyamides, polyethylenes, polypropylenes, polyesters, polyurethanes, polyvinyl chlorides, epoxy resins and so on. The resin binders in the toner may be a single component or a mixture of various binder resins. Preferably, the binder resin has a weight-averaged molecular weight of between 200 and 100,000, for example a weight-averaged molecular weight of between 500 and 50,000, more preferably a weight-averaged molecular weight of between 1000 and 30,000. This molecular weight may, for example, be adapted to the required mechanical properties of the image or to the intrinsic properties of the image-forming process. The glass transition temperature of the binder resin is in the range 45° C. to 85° C., more preferably in the range 50° C. to 75° C., or alternatively, in the range 55° C. to 80° C. In an even more preferred embodiment, the glass transition temperature of the binder resin is in the range of 60° C. to 70° C.

Suitable epoxy resins, for example, are the Epikote resins (Shell), such as Epikote 828, Epikote 838 and Epikote 1001. In addition, many other epoxy resins may be used which contain one or more epoxy groups per molecule. These epoxy resins may be saturated or unsaturated, aliphatic, cycloaliphatic, aromatic or heterocyclic, and may be substituted with substituents such as halogen atoms, hydroxyl groups, alkyl, aryl or alkaryl groups, alkoxy groups and the like. The phenol compounds suitable in the toner powder according to the invention are those compounds which have at least one hydroxyl group bonded to an aromatic nucleus. Mainly etherification takes place on reaction between the epoxy resin and the phenol compound, thereby forming the epoxy resin. However, not all epoxy groups present may react with a phenol compound, resulting in the presence of unreacted epoxy groups within the resin. It may be desirable to control the amount of free epoxy groups present within the resin, for example because of the HSE effects of epoxy functional groups, or because of the reactivity of the resin towards other components present in the toner. The amount of free epoxy groups may be suitably controlled by adding a blocking agent. A blocking agent is a compound, which reacts with the epoxy group, such that the epoxy group is converted into another functional group, for example an ether functional group. Thereby, the epoxy group is prevented from reacting further. For example, a phenol compound having one hydroxyl group bonded to an aromatic nucleus may be used for as blocking agent in a blocking reaction of the epoxy resin.

Examples of suitable phenols as blocking agent are phenol, p-cumylphenol, o-tert.butylphenol, p-sec. butylphenol, octylphenol, p-cyclohexylphenol and -naphthol. Other blocking agents, for example, monofunctional carboxylic acids, are also suitable. Examples of suitable carboxylic acids are phenylacetic acid, diphenylacetic acid and p-tert.butylbenzoic acid.

The selection of a specific polyester resin depends on the required use of the toner powder. Suitable diols are, inter alia, etherified bisphenols, such as polyoxyethylene(2)-2,2-bis(4-hydroxyphenyl)-propane, polyoxypropylene(3)-2,2-bis(4-hydroxyphenyl)-propane, polyoxypropylene(3)-bis(4-hydroxyphenyl)-sulphone, polyoxyethylene(2)-bis(4-hydroxyphenyl)-sulphone, polyoxypropylene(2)-bis(4-hydroxyphenyl)-thioether and polyoxypropylene(2)-2,2-bis(4-hydroxyphenyl)-propane or mixtures of these diols, in which a plurality of oxyalkylene groups per molecule of bisphenol may be present. This number is preferably between 2 and 3 on average. It is also possible to use mixtures of etherified bisphenols and (etherified) aliphatic diols, triols, etc. Examples of suitable carboxylic acids are phthalic acid, terephthalic acid, isophthalic acid, cyclohexane dicarboxylic acid, fumaric acid, maleic acid, malonic acid, succinic acid, glutaric acid, adipic acid and anhydrides of these acids. Furthermore esters, e.g. methyl esters of these carboxylic acids, are suitable.

In another embodiment the binder resin comprises a mixture of a polyester resin and an epoxy polymer. In particular in the toner according to the invention, the ratio between the polyester resin and the reaction product of the epoxy resin and phenol compound ratio may be varied between 80:20 and 20:80, such as may be varied between 70: and 30:70, more preferably may be varied between 60:40 and 40:60. The temperature difference between the glass transition temperature and the lower fusing limit of the toner powders according to the embodiment is also significantly reduced in comparison with the temperature difference between the glass transition temperature and the lower fusing limit of toner powder prepared with polyester resin without the addition of the epoxy reaction product. Consequently, while powder stability is retained the fixing temperature of such toner powders is lower so that the energy consumption for fixing is reduced.

In a further embodiment the polyester resin has a number-averaged molecular weight of at least 2500, for example 2500-250 000, preferably 3000-100 000, more preferably 5000-50 000. The epoxy resin has a number-averaged molecular weight of less than 1200, for example 100-1200, preferably 200-500 and the epoxy groups of the epoxy resin are blocked for at least 60% by a monofunctional phenol compound, for example 60%-100%, preferably 65%-95%, more preferably 70%-90%.

Particularly preferred is a toner powder whose polyester resin is mainly a reaction product of ethoxylated 2,2-bis(4-hydroxyphenyl)propane, a phtalic acid and adipic acid. More preferably the phtalic acid is terephthalic acid or isophthalic acid. A toner powder of this kind has a sufficiently high glass transition temperature and also a surprisingly low lower fusing limit, so that the energy required to fix a toner image prepared with this toner powder is relatively low.

In a further embodiment, the binder resin provides a strong affinity towards the wax. In case the binder resin provides a strong affinity, the wax is more strongly retained in the toner. Moreover, in case the binder resin provides a strong affinity, the wax may be better miscible with the wax. The migration of the finely dispersed wax in the toner particle towards the surface of the toner is restricted by the affinity of the wax to the binder resin in the toner. As a result the durability of the developing performance of the toner containing the wax is increased. The affinity of the binder resin to the wax may be observed in several ways. For example in case the wax is very finely dispersed in the binder resin, the wax having domains at a sub micron level, this is an indication of a strong affinity of the binder resin and the wax.

In another embodiment, the strong interaction of the wax in the binder resin may be observed in a deviation of the loss compliance (J″) of the toner in the temperature range of the melt transition range of the finely dispersed wax. The loss of compliance is derived from G′ and G″. The moduli G′ and G″ are measured within a temperature range of 60° C. to 160° C. and within a certain frequency range. The curves found are then reduced to one curve at one temperature, the reference temperature. From this reduced curve the loss compliance (J″) is calculated as a function of the frequency. In case the loss compliance (J″) of the toner has a local minimum peak in the melt transition range of 110° C. to 140° C., the binder resin has a strong affinity to the wax and the wax is better retained in the toner.

The toner further comprises an inorganic component. The inorganic component may be a colouring agent, an magnetic attractable particle and/or an electrical conductive particle. The inorganic component may function as a pigment in the toner and may be e.g. a magnetic pigment. The inorganic component may be a metal particle, a particle of a metal salt, or the like. By proper mixing of the inorganic component in the toner a colour of the toner, a magnetic property of the toner and/or the electrical property of the toner may be easily adjusted using conventional mechanical processes. Preferably, the inorganic component may be a metal salt, such as, but not limited to, a metal oxide or a metal sulphide. Preferably, the metal salt is a salt of a transition metal, such as iron oxide, nickel oxide, zinc oxide, chromium oxide, manganese oxide, cobalt oxide, silver oxide, iron sulphide, nickel sulphide.

The inorganic component is preferably uniformly dispersed in the binder resin of the toner, the dispersion of the inorganic component in the binder resin of the toner having a number average diameter of less than 10 μm, preferably 10 μm-0.05 μm, more preferably of 5 μm-0.1 μm, even more preferably of 2 μm-0.2 μm.

The addition of the inorganic component to the toner may provide a further enhancement of the containment of the wax inside the toner particle. The inorganic component in the toner may provide affinity towards the applied wax. The migration of the finely dispersed wax in the toner particle towards the surface of the toner may be restricted by the affinity of the wax to the inorganic component in the toner. As a result the durability of the developing performance of the toner containing the wax is increased. Without wanting to be bound to any theory, the affinity of the inorganic component to the wax is believed to result from interactions between polar groups within the wax, with the inorganic component. The oxidized polyalkylene wax may comprise polar groups, for example carboxylic acid groups. The inorganic component, such as a metal oxide, is polar, too. The polar groups of the oxidized wax and the polar groups of the inorganic component may interact which may result in an affinity between the oxidized wax and the inorganic component.

Optionally, the carboxylic acid groups of the oxidized polyalkylene group may be converted into a different functional group, such as an ester functional group or an amide functional group. Ester functional groups or amide functional groups may be polar, too and therefore may also interact with the inorganic component. All carboxylic acid groups of the wax may be converted, or a part of the carboxylic acid functional group may be converted, thereby changing the end groups of the wax component. By suitably selecting the nature of the endgroup and the percentage of the carboxylic acid groups that are converted, the properties of the wax may be suitably tuned.

The affinity of the inorganic component to the wax may be observed in several ways. For example in case the wax forms domains together with the inorganic components in the binder resin of the toner, this is a clear indication of a strong affinity of the inorganic component with the wax.

Alternatively, the rheological behaviour of the toner composition above the melting transition temperature of the wax is used as indication of the affinity. Above the melting transition temperature of the wax, the finely dispersed wax is molten and will have the tendency to migrate and form bigger domains of wax in the binder resin. As a result of the bigger domains of molten wax the loss compliance (J″) of the toner composition will increase. In case the addition of the inorganic component to the toner composition leads to a more stable loss compliance (J″) of the toner composition above the melting transition temperature of the wax, this indicates that the inorganic component prevents or at least retards the migration of the wax in the toner.

The strong interaction between the oxidized polyalkylene wax and the inorganic component results in the wax being strongly retained in the toner matrix comprising the inorganic component. When the wax is strongly retained in the toner matrix, contamination of the developing means of a printing system may be decreased.

The wax is finely dispersed in the binder resin. In particular the domains of wax in the dispersion of the wax in the binder resin of the toner may have a diameter of less than about 2 μm, preferably 2 μm-0.01 μm, more preferably 1 μm-0.05 μm, even more preferably 0.5 μm-0.1 μm. In addition, the dispersability of the wax in the binder resin of the toner is closely related to kind, polarity, viscosity and so on of the wax which is used, so that high-melting waxes being excellent in dispersability in the binder resin can be used. Therefore, production processes of the high-melting toner and durability of the toner can also be easily improved.

The toner according to the present invention is suitable for developing a toner image. The toner may be a single component toner or a two-component developer, comprising a toner particulate and a magnetic carrier.

The single component toner may be a magnetic attractable toner. The magnetic property may be provided to the toner by incorporating a magnetic component into the toner. The magnetic component may be a magnetite, a ferrite or the like.

In addition, the toner may also contain colouring material, which may consist of carbon black, a pigment or a dye. The pigment or the dye may be either inorganic or organic. The toner powder may also contain other additives, the nature of which depends on the way in which the toner powder is applied. Thus toner powder for the development of latent magnetic images, toner powder which is fed by magnetic conveying means to an electrostatic image to be developed, or toner powder for Magnetic Ink Character Recognition (MICR) applications, will also have to contain magnetisable or magnetic material, usually in a quantity of 30 to 70% by weight. Toner powders which are used for the development of electrostatic images may also be rendered electrically conductive in manner known per se, by finely distributing electrically conductive material, e.g. carbon, tin oxide, copper iodide or any other suitable conductive material, in appropriate quantity in the powder particles or depositing it on the surface of the powder particles. The electrical conductive surface layer of the toner may comprise a component selected from a) a carbon particulate, b) an electrical conductive inorganic component, such as a metal oxide particle, c) an electrical conductive polymer, such as a doped conjugated conductive polymer, or d) a combination of these components.

If, for the development of electrostatic images, the toner powder is used in a so-called two-component developer, in which the toner powder is mixed with carrier particles, then the toner powder particles may also contain a charge control agent that causes the toner powder particles, upon tribo-electric charging, to assume a charge whose polarity is opposed to that of the electrostatic image to be developed. The known materials suitable for this purpose can be used as carrier particles, e.g. iron, ferrite or glass, while the particles may be provided with one or more layers completely or partially covering the carrier particles.

The known materials may be used for the magnetisable or magnetic material, electrically conductive material or charge control agent. Also possible are additions, for example, to increase the powder stability or improve the flow behaviour. Silica is a conventional additive for this purpose for example.

In addition, to prepare a toner according to another embodiment of the present invention, it is preferred that the inorganic component is a magnetic component. By the use of a magnetic component a magnetically attractable toner is obtained suitable for a magnetic single component development system. The magnetic single component toner having a high-melting wax provides a simple and compact development system, while the development performance is constant in time. The magnetic component is preferably uniformly dispersed in the binder resin of the toner, the dispersion of the magnetic component in the binder resin of the toner having an number average diameter of less than 10 μm, more preferably of less than 5 μm, even more preferably of less than 2 μm.

In particular the toner comprising the magnetic component may have a magnetisation in the range of 10 mVs/ml to 50 mVs/ml, such as in the range 10 mVs/ml to 40 mVs/ml, preferably in the range 10 mVs/ml to 20 mVs/ml or alternatively in the range 25 mVs/ml to 35 mVs/ml. It is known that this range of magnetisation of toner may be obtained by dispersing a proper amount of a magnetic component in the binder resin.

In addition, to prepare a toner according to another embodiment of the present invention, it is preferred that the viscosity of the wax is at least 0.5 Pa·s at 140° C. The lower limit of 1 Pa·s enhances the dispersing of the wax in the toner mixture during a melt kneading process at elevated temperature. In case the viscosity is lower than 1 Pa·s at 140° C. it may lead to a less uniform dispersed wax in the binder resin of the toner during mixing.

In a further embodiment the viscosity of the wax is at most 10 Pa·s at 140° C. In case the viscosity of the wax is lower than 10 Pa·s at 140° C. this wax is found to improve the mechanical shear robustness of the toner particles in a particular printing system. Especially in a high-speed printing system in which dry toner particles may be mechanically sheared with high shear rates, such as in a shear load of a rotating toner brush by a stripping element in a toner image developing process, the developing performance of the toner comprising a high melting wax in the printing system may be improved.

Thereby the relation has been determined, that a toughness or brittleness of the solid wax below melting temperature is related to the viscosity of the wax above melting temperature. In case a wax has a higher viscosity than 10 Pa·s at 140° C., the use of said wax in a toner may result in a filming contamination at high shear rates. Therefore a tough solid wax in a toner may in a high-speed printing process cause a filming contamination. The use of a high-melting wax in a toner, the wax having a viscosity which is lower than 10 Pa·s at 140° C. provides the advantage of an improved solid robustness at a high shear loads, for example the shear loads the toner comprising the wax experiences during transfer or fusing.

In a particular embodiment the viscosity of the wax is in the range 0.5 Pa·s to 10 Pa·s at 140° C., preferably the viscosity of the wax is in the range 1.0 Pa·s to 8 Pa·s at 140° C., even more preferably the viscosity of the wax is in the range 2 Pa·s to 5 Pa·s at 140° C. The viscosity of the waxes is determined using an Anton Paar MCR 301 machine, with a CP50-2 geometry and a gap of 600 μm, a shear rate of 0.01 s⁻¹-1000 s⁻¹ and at a temperature of 140° C.

In addition, to prepare a toner according to another embodiment of the present invention, it is preferred that the oxidized polyalkylene wax, such as the polyethylene wax has a melting peak in a temperature range of 120° C. to 135° C. at the time of temperature rise in the DSC thermogram measured using a differential scanning calorimeter, wherein the wax melting transition at the time of temperature rise in the DSC thermogram was measured at a heating rate of 10° C./min according to the ASTM D3418 Standard using a TA Instruments Q2000 differential scanning calorimeter.

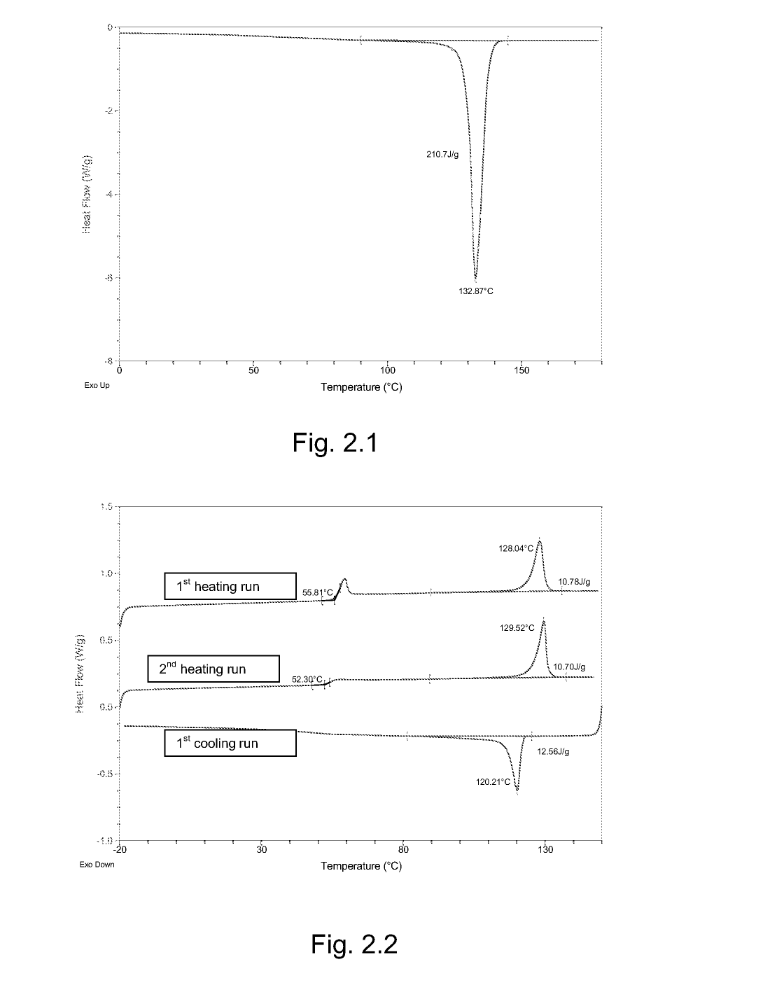

An example of a DSC thermogram of a wax according to the present invention is shown in FIG. 2.1. The wax used here is AC 330, commercially available from Honeywell. The thermogram shown the amount of heat that is absorbed by a sample as a function of temperature. The DSC thermogram shown in FIG. 2.1 shows a single peak, having a maximum at 132.87° C. This maximum is the melting peak. At this temperature, the sample absorbs most energy, and therefore, the endothermic energy shows a maximum.

In an embodiment, the oxidized polyalkylene wax has a polydispersity D in the range of 1.0-3.5. The polydispersity D is the ratio between the weight average molecular weight Mw of the wax and the number average molecular weight Mn of the wax. The melting peak is a temperature at the time of temperature rise in the DSC curve at which the endothermic enthalpy has a maximum. The combination of said high-melting peak with a polydispersity D of less than about 3.5 provides a high melting oxidized polyethylene wax, which fulfils the requirements of substantially no melting of the wax below 110° C. The melting peak temperature of the wax is near to the lower limit temperature of the melting transition range of the wax and thus the wax provides in the toner a narrow melting transition. The narrow melting of said wax having a polydispersity of less than about 3.2, provides a quick melting when heated, and also causes a fast decrease in melt viscosity. In this way it becomes possible to balance dispersability of the wax in the binder resin of the toner, the fixing performance of the toner and prevent contamination of the development means.

In a further embodiment, the oxidized polyethylene wax may more preferably have a polydispersity between 1.5 and 3.5. A polydispersity lower than 1.5 requires an additional refractionation process of commonly available oxidized polyethylene waxes. Such a refractionated wax may be more expensive or may be even economically not feasible as it is obtained by further processing of the wax also leading to a lower yield of production. In an further embodiment, the oxidized polyethylene wax may more preferably have a polydispersity between 1.5 and 3.3. In an even further embodiment, the oxidized polyethylene wax may more preferably have a polydispersity between 1.5 and 3.0.

In addition, to prepare a toner according to another embodiment of the present invention, it is preferable that the wax has an acid value from 5 to 50 mg KOH/g. In order to further improve the balance of properties, such as dispersability in the binder resin, affinity of the wax with the inorganic component and obtaining the toner composition at high yield by using conventional mechanical processes, the acid value of the wax is within the range from 5 to 50 mg KOH/g. In case the acid value of the wax is lower than 5 mg KOH/g, the dispersion size of the wax in the binder resin of the toner becomes more than 2.0 μm and the production yield of the toner is reduced. In case the acid value of the wax is higher than 50 mg KOH/g it becomes more difficult to disperse the inorganic component in the toner.

In a further embodiment it is even more preferably that the acid value of the wax is within the range from 10 to 40 mg KOH/g. A wax having said range of acid value provides a better balanced production process of the toner composition, obtaining a proper dispersion of the wax in the binder resin, while not disturbing the mixing of the other components in the toner composition. In a further embodiment, the acid value of the wax is within the range of 20 to 35 mg KOH/g.

In addition, to prepare a toner according to another embodiment of the present invention, it is preferred that the binder resin has an acid value from 5 mg KOH/g to 50 mg KOH/g. For example the binder resin has an acid value from 6 mg KOH/g to 40 mg KOH/g, such as 8 mg KOH/g to 25 mg KOH/g or 15 mg KOH/g to 35 mg KOH/g. More preferably the binder resin has an acid value from 7 mg KOH/g to 20 mg KOH/g, such as 7 mg KOH/g to 10 mg KOH/g or 9 mg KOH/g to 16 mg KOH/g

In addition, to prepare a toner according to another embodiment of the present invention, it is preferred that said wax dispersion has a number average diameter in the range of 0.2 μm to 3 μm, such as a number average diameter in the range of 0.5 μm to 2 μm. At the lower limit of the average diameter the fixing performance becomes poor. This indicates, that if the dispersed size of the wax becomes too small, the dispersed wax needs more time to migrate to the surface of the toner image. Moreover at a smaller diameter than 0.2 μm the wax may loose its preference to accumulate on the surface of the toner.

In addition, to prepare a toner according to another embodiment of the present invention, it is preferred that the wax has a density in the range 0.97 to 1.00 g/cm³. Such a high-density wax provides the advantage that the solid wax at low temperature provides a further improvement on the print robustness of the toner image.

In addition, to prepare a toner according to another embodiment of the present invention, it is preferred that the wax has in said melting transition range an endothermic enthalpy of at least 200 J/g at the time of temperature rise in the DSC curve measured using a differential scanning calorimeter. The endothermic enthalpy of the high-melting wax is related to the crystallinity of the solid wax. Both the print robustness of the toner image and the long term development performance is balanced by a wax having a high endothermic enthalpy of at least 200 J/g. The crystallinity of the high-melting wax can be estimated by applying the theory of the endothermic enthalpy of a 100% crystalline polyalkylene wax, which is about 294 J/g. Using the calculation method ([Heat of enthalpy [Hm] j/g/294 J/g]×100=degree of crystallinity), the high-melting wax of the present invention has an estimated crystallinity of at least 70% or more. For example, in the DSC thermogram of wax AC 330, commercially available from Honeywell, shown in FIG. 2.1, shows that the enthalpy of this wax is 210.7 J/g.

In an embodiment of the present invention, to prepare the toner of the present invention, the amount of wax is from 1 wt % to 10 wt % based on the total weight of the toner.

In case the amount of wax is less than 1 wt %, enough effect of the wax may not be obtained. On the other hand, if the amount of wax is more than 10 wt %, the fine dispersion of the wax in the toner composition may not be obtained.

Preferably, the amount of wax is from 3 wt % to 8 wt % based on the total weight of the toner. More preferably, the amount of wax is from 4 wt % to 7 wt % based on the total weight of the toner.

In an embodiment, the amount of the inorganic component is from 30 wt % to 70 wt % based on the total weight of the toner. The amount of the inorganic component is related to the magnetic forces employed in the development process. In case the amount of magnetic component is less than 30 wt %, the development performance may not be obtained. On the other hand, if the amount of the magnetic component is more than 70 wt % the dispersion of the magnetic component may become troublesome, and may also lead to an accumulation of the toner in the development means. More preferably the amount of magnetic component is from 40 wt % to 60 wt %. Even more preferably the amount of magnetic component is from 45 wt % to 55 wt %.

In addition, to prepare a toner according to another embodiment of the present invention, it is preferred that the binder resin, the magnetic component and the wax are mixed by a melt kneading process. The narrow-melting wax of the present invention enables a proper mixing in the melt kneading process at a temperature close to the peak temperature of the melting range of the wax. The melt kneading process close to the peak temperature of the melting range of the wax provides sufficient mechanical shear to balance the dispersing of the wax and the mixing of the magnetic component in the binder resin of the toner.

In another aspect of the present invention, the invention relates to a printing system for applying a toner on an image receiving medium, the toner comprising:

(i) a binder resin,
(ii) an inorganic component, preferably a magnetic component, and
(iii) a wax being finely dispersed in the binder resin, the wax having a wax melting transition in a temperature range of 110° C. to 140° C. at the time of temperature rise in the DSC curve measured using a differential scanning calorimeter, wherein the lower temperature limit of said wax melting transition is at least 110° C. or higher, the printing system comprising:
(A) a developing means configured for in operation developing a toner image,
(B) an intermediate image bearing means configured for in operation transferring the toner from the developing means to the intermediate image bearing means in a first transfer zone and for transferring the toner from the intermediate image bearing means to an image receiving medium in a second transfer zone.

By selection of the high-melting wax a toner printing system is obtained for providing the balance of improved toner image robustness and the maintaining of the development performance.

The toner of the present invention is capable of being satisfactorily transferred on a receiving material in a wide temperature range. In case the printing system, wherein the toner according to the present invention may be used, comprises a two-step procedure to transfer the toner onto an image receiving medium, the printing system may comprise an intermediate image bearing means. In such a printing system, the toner may be transferred to the intermediate image bearing means in a first transfer zone and may be transferred from the intermediate image bearing means to the image receiving member in a second transfer zone. In accordance with the present invention, in particular the toner image may be developed by the developing means and said developed toner image may be transferred to the intermediate image bearing means in the first transfer zone in a temperature range from 20° C. to 60° C. In particular the transfer of the toner image from the intermediate image bearing means to the image receiving medium in the second transfer zone may be carried out in a temperature range from 80° C. to 110° C. However, the toner according to the present invention is not limited to a toner suitable only for use in a printing system applying a two-step procedure to transfer the toner onto an image receiving medium. The toner may also be applied in other printing systems, such as a printing system, wherein the toner image is transferred to the image receiving medium without the use of an intermediate image bearing means.

In another embodiment of the present invention, the printing system further comprises (C) a fixing means configured for in operation fixing the toner onto an image receiving medium by applying a fixing pressure and a fixing temperature. The fixing of the toner may be carried out at the same time and in cooperation with the transfer of the toner from the intermediate image bearing means to the image receiving medium. This embodiment enables a compact and simple construction for transferring and fixing the toner onto the image receiving medium.

In another embodiment the fixing means is arranged away from the second transfer zone, and the toner image is fixed onto image receiving medium after the transfer of the toner image on the image receiving medium. This embodiment provides a bigger operational freedom to adjust the fixing means. For example the fixing temperature may be increased, while maintaining a lower temperature of transfer. Also additionally a fluid release agent, such as an oil, may be provided during fixing, in order to improve the fixing temperature latitude and/or fixing speed.

In a preferred embodiment the printing system comprises two image-forming units and two images may in operation be transferred simultaneously from two intermediate image bearing means to both opposite surfaces of the image receiving medium in the second transfer zone. The transfer nip in the second transfer zone is formed by arrangement of the two intermediate image bearing means near the second transfer zone. The two intermediate image bearing means are configured to in operation contact the image receiving medium in the second transfer zone. The fixing means is arranged away from the transfer zone and is configured in operation to fix the toner images applied onto at least one of the opposite sides of the image receiving medium. As a result both toner images may be simultaneously fixed on the image receiving medium.

During transfer the toner image may be fixed such that it is scarcely removed, if at all, under mechanical loads such as folding and rubbing. The fixing temperature in these conditions should be as low as possible in connection with minimum energy consumption. Alternatively the toner image may be fixed onto the image receiving medium in a temperature range of from 120° C. to 180° C. Preferably, the toner image may be fixed onto the image receiving medium in a temperature range of from 125° C. to 170° C. More preferably, the toner image may be fixed onto the image receiving medium in a temperature range of from 130° C. to 160° C. Said fixing temperature may improve the print robustness even further by further flattening the toner images and/or accumulation of the wax on the surface of the toner image.

The working range of a toner powder may preferably be so wide that any temperature inequalities occurring in the fixing station are taken care of. The working range of a toner powder is defined as the temperature range between the lower fusing limit, the lowest possible fixing temperature at which the toner image is still adequately fixed, and the upper fusing limit, the maximum fixing temperature at which, using for example the hot-roll fixing method, no toner is deposited on the fixing roller (the “hot roll”).

In another aspect of the present invention, the invention relates to method for producing a toner comprising the steps of: (i) selecting a binder resin, (ii) selecting an inorganic component, preferably a magnetic component, (iii) selecting a wax, the wax having a wax melting transition, in a temperature range of 110° C. and 140° C. at the time of temperature rise in the DSC thermogram measured using a differential scanning calorimeter, wherein the lower temperature limit of said wax melting transition is at least 110° C. or higher;

(iv) mixing the inorganic component and the binder resin in a melt kneading process at a temperature above 80° C., such that the magnetic component is dispersed in the binder resin, said magnetic component dispersion having a number average diameter of less than 5 μm, more preferably less than 2 μm,
(v) mixing the wax in the binder resin in a melt kneading process in a melt temperature range between 110° C. to 140° C., such that the wax is finely dispersed in the binder resin.

In particular the domains of wax in the dispersion of the wax in the binder resin of the toner may have a diameter of less than about 2 μm.

In another embodiment of the method according to the present invention, step (v) mixing the wax in the binder resin is carried out after the inorganic component has been mixed with the binder resin in step (iv).

In another embodiment of the method according to the present invention, step (iv) the mixing of the inorganic component and the binder resin is carried out at a lower temperature than step (v) the mixing of the wax with the melt of the binder resin.

### DETAILED DESCRIPTION

Embodiments of a toner comprising a high-melting wax for improving robustness of a toner image provided by a printing process of the toner will be concretely described with respect to binder resin, inorganic component and wax, which are main components, surface coatings and colouring agents, which are optional components, and property of the obtained toner, hereinafter.

The present invention will be described in detail using examples hereafter. It is naturally to be appreciated that the following description is merely exemplary and that the scope of the invention is not intended to be limited by the following description if otherwise specified.

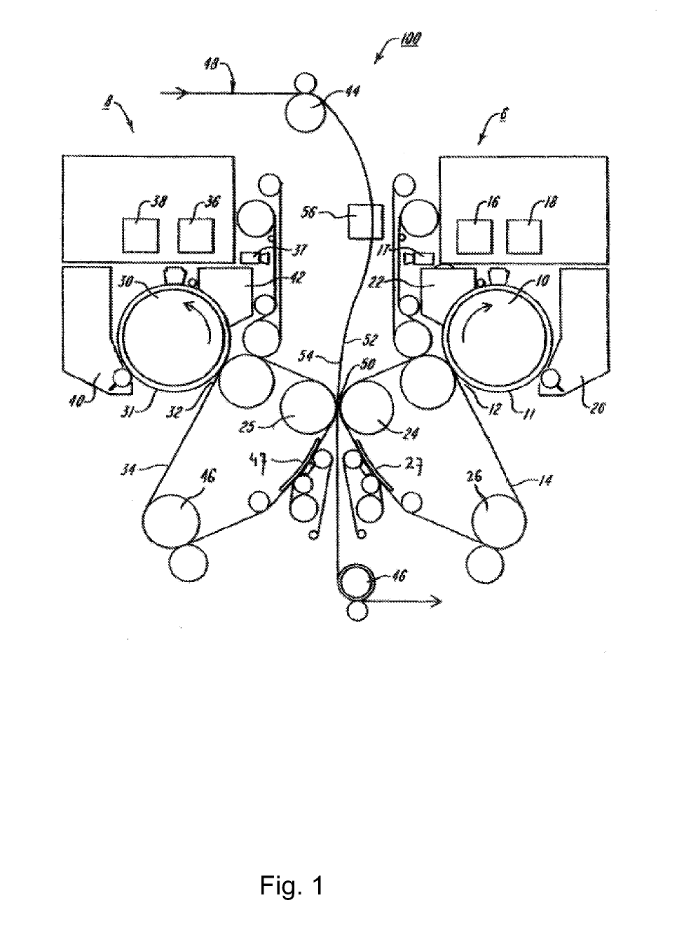

FIG. 1 is a diagram showing a printer comprising two image-forming units.

FIG. 2.1: is a DSC curve during the first scan of heating of the wax used in the toner of example 3.

FIG. 2.2: is a DSC curve of toner according to example 3, showing the wax melting transition of the wax AC-330 in the toner and the Tg of the toner binder resins.

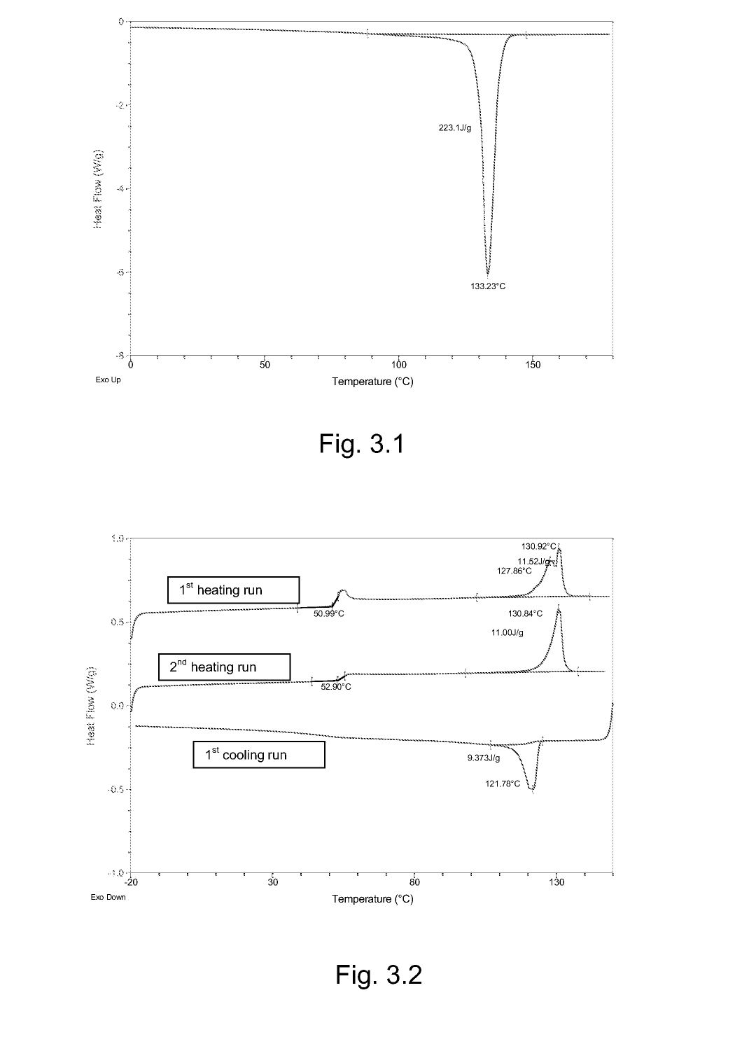

FIG. 3.1: is a DSC curve during the first scan of heating of the wax used in the toner of example 6.

FIG. 3.2: is DSC curve of toner according to example 6, showing the wax melting transition of the wax AC-316 in the toner and the Tg of the toner binder resins.

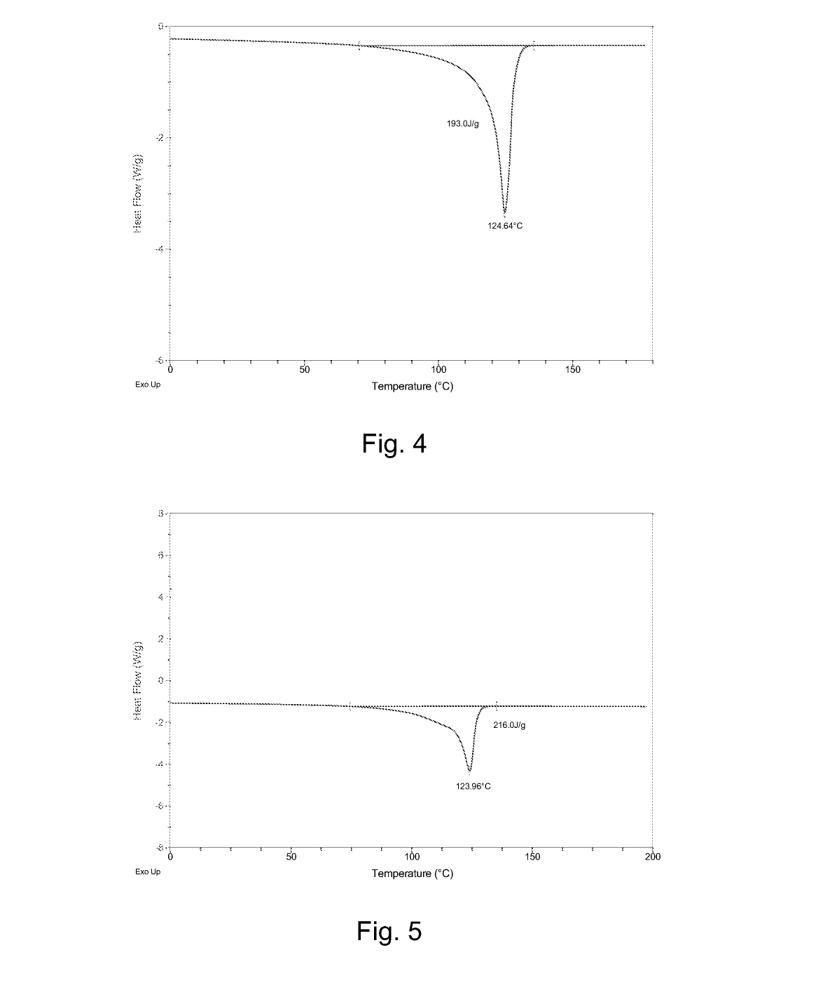

FIG. 4: is a DSC curve during the first scan of heating of the wax used in the toner of comparative example 1.

FIG. 5: is a DSC curve during the first scan of heating of the wax used in the toner of comparative example 7.

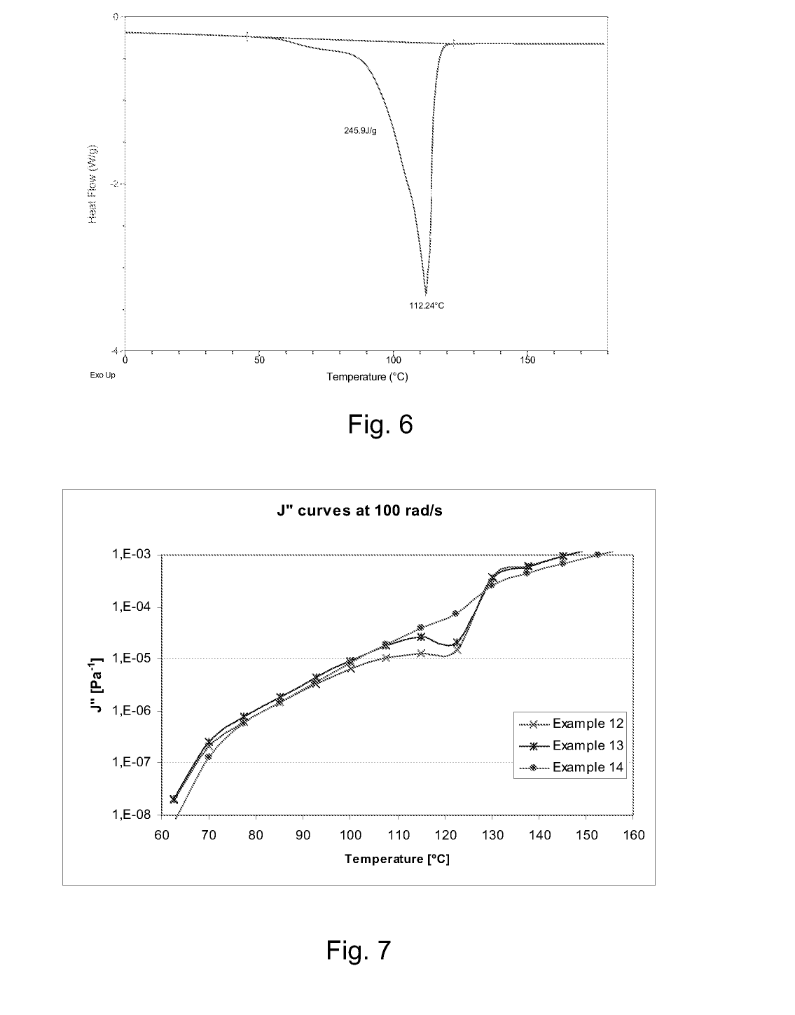

FIG. 6: is a DSC curve during the first scan of heating of the wax used in the toner of comparative example 6.

FIG. 7: shows the Loss Compliance of toners of Examples 13-15 measured at 100 rad/s.

### PRINTING SYSTEM

FIG. 1 is a diagram showing a printer 100 comprising two image-forming units 6 and 8. This printer is known from U.S. Pat. No. 6,487,388. In this embodiment, the printer is equipped to print on a loose sheet of image receiving medium 48 (shown). To this end, the printer is equipped with clamping elements 44 and 46. In another embodiment (not shown), the printer has been modified to print on an endless image receiving medium. The developing means 6 and 8 may be used to form images on the front 52 and back 54 respectively of the image receiving medium 48, said images being transferred onto this medium at the level of the single transfer nip 50. Toner developing means 6 comprises a writing head 18 consisting of a row of individual printing elements (not shown), in this embodiment a row of so-called electron guns. By application of this writing head, a latent electrostatic charge image may be produced on the surface 11 of developing member 10. A visible powder image is developed on this charge image, using a toner inside this development terminal 20. This toner consists of individual toner particles which have a core that is based on a plastically deformable resin. The toner particles also comprise a magnetic component that is dispersed within the resin. The particles are coated on the outside in order to control their charging. At the level of a primary transfer nip 12, the visible powder image is transferred onto intermediate image bearing means 14. This means 14 is a belt that consists of silicon rubber supported by a tissue. Toner residues on the surface 11 are removed by application of cleaning terminal 22, following which the charge image is erased by erasing element 16. Corresponding elements of toner developing means 8 are indicated using the same reference numbers as the elements of unit 6 but increased by 20 units (as described in detail in the patent mentioned).

The images that are formed on the intermediate image bearing means 14 and 34 are transferred onto the image receiving medium 48 at the level of the transfer nip 50. To this end, both intermediate image bearing means are configured to contact the image receiving medium by application of the print rollers 24 and 25, where the images are transferred onto and fused with medium 48 as a result of this pressure, heat and shearing stresses. To this end, the image receiving medium is preheated in terminal 56 and the intermediate image bearing means themselves will be heated by heating sources located in rollers 24 and 25 (not shown). Beyond transfer nip 50, the intermediate image bearing means are cooled down in cooling terminals 27 and 47. This is to avoid the intermediate image bearing means becoming too hot at the level of the primary transfer nips 12 and 32 respectively. When the printer is on standby, the temperature of the intermediate image bearing means is lower than for a proper transfuse step in nip 50. As soon as it is known when the next image receiving medium needs to be printed, a signal will pass to the heating elements located in the rollers 24 and 25 to heat the corresponding intermediate image bearing medium.

As is known from U.S. Pat. No. 5,970,295, both images in the feed-through direction of the image receiving medium 48 are brought into register with one another by checking the writing moments of both writing heads 18 and 38, as well as the rotating speeds of developing members 10 and 30, and the intermediate image bearing means 14 and 34. In the embodiment shown, the intermediate image bearing means are driven via rollers 26 and 46. The rotating speeds of the intermediate image bearing means 14 and 34 will thus be controlled and kept equal. Developing members 10 and 30 do not have their own drive facility and are driven by the mechanical contact between the intermediate means in the transfer nips 12 and 32 respectively. As both sets of intermediate image bearing means and image receiving media are never exactly the same length, the time that elapses between writing a latent image using writing head 18 and transferring the corresponding toner image in the secondary transfer nip 50 for the drive shown will always be different to the time that elapses between writing a latent image using writing head 38 and transferring the corresponding toner image in the secondary transfer nip 50. This time difference can be compensated by adapting the writing moment of either writing head.

### Analysis

The DSC thermogram of the waxes and of the toners comprising the waxes is determined using a differential scanning calorimeter at a heating rate of 10° C./min at the time of rise according to the ASTM D3418 Standard using a TA Instruments Q2000 Differential Scanning calorimeter. The endothermic enthalpy is measured during the first and second scan of heating. The lower limit temperature and upper limit temperature of the wax melting transition is obtained from both the first and second scan of heating. In case there is a deviation in the lower and/or upper temperature limit measured during the first scan of heating, compared to the second scan of heating, the average of the two values of the lower temperature limit, resp. upper temperature limit value was used. The crystallisation enthalpy of the wax and of the toners comprising the waxes is measured at the time of cooling down using a differential scanning calorimeter at a cooling rate of 10° C./min.

The working range of the toner transfer can readily be determined for a specific device by measuring the temperature range within which complete transfer and good adhesion of the powder image are obtained. A reasonable indication of the position and size of the working range of a specific toner powder can be obtained by measuring the visco-elastic properties of the toner powder. Generally speaking, the working range of the toner powder corresponds to the temperature range within which the loss compliance (J″) of the toner powder, measured at a frequency equal to 0.5 times the reciprocal of the contact time in the device used for performing the process according to the invention, is between 10⁻⁴ and 10⁻⁶ m²/N.

The visco-elastic properties of the toner powder are measured in an ARES rheometer by TA instruments, the moduli G′ and G″ being determined as a function of the frequency at a number of different temperatures. The moduli G′ and G″ are measured in a temperature range of 60° C.-160° C. and a frequency range of 40-400 rad s⁻¹ and a strain of 1%. The curves found are then reduced to one curve at one temperature, the reference temperature. From this reduced curve the loss compliance (J″) is calculated as a function of the frequency. The displacement factors of the lower fusing limit and upper fusing limit temperatures (J″=10⁻⁶ and J″=10⁻⁴ m²/N respectively) of the working range can then be read off from the loss compliance-frequency-curve. The lower and upper fusing limit temperatures of the working range can then be calculated by means of the WLF equation compiled from the displacement factors found at different temperatures.

The weight-averaged molecular weight of the binder resins and waxes is determined by GPC measurement with UV and refractive index detection. For GPC measurements on the waxes, a Varian PL-GPC220 with Viscotek 220R viscosimeter was used, provided with Viscotekk TriSEC 2.7 software and a PL 13 μm mixed olexis column. 1,2,4-Trichlorobenzene was used as eluent and the GPC column oven was at 160° C.

The polyester resin was analysed a Varian PL-GPC220 with Viscotek 220R viscosimeter, provided with Viscotekk TriSEC 3.0 software and a set of 4×PL gel Mixed-C (5 μm) columns and a PL-gel guard column (5 μm). The column temperature was 30° C. and the TDA-detector temperature was 30° C. THF (Rathburn, HPLC grade) to which 5 wt % acetic acid was added, was used as eluent at a flow rate of 1 ml/min. Epoxy polymer was analysed as the polyester resin, but the columns used were 2×PL-gel mixed E (3 μm) column and a PL-gel guard column (5 μm).

The quality of the dispersion of the wax in the toner binder resin is analysed by using SEM pictures of the extrudated toner mixture. The SEM pictures were generated using a SEM JSM 6500 F machine. The average dispersion size of the wax domains is determined using SEM pictures of the extrudated toner mixture and of the classified toner particles.

The quality of the dispersion of the iron oxide particles in the toner binder resin is analysed by using SEM pictures of the extrudated toner mixture. The average dispersion size of the iron oxide is determined using SEM pictures. Furthermore an indication is given about the uniformity or inhomogeneity of the dispersion in the binder resin.

Magnetisation of the toner powder is determined using a Vibrating Sample Magnetometer, of the type LakeShore 7300. The saturation magnetization value can be defined as an amount of magnetic memory under the condition where a magnetic field at 10 kilo-Oersted was applied to magnetic powder up to saturation. The saturation magnetization value of (magnetic) toner powder can be calculated by analyzing a hysteresis curve of that powder.

The resistance may be measured in a manner generally known, by measuring the dc resistance of a compressed powder column. A cylindrical cell is used to this end, having a base surface area of 2.32 cm² (steel base) and a height of 2.29 cm. The toner powder is forcibly compressed by repeatedly adding toner and tapping the cell 10 times on a hard surface between each addition. This process is repeated until the toner will not compress any further (typically after adding and tapping 3 times). Next, a steel conductor having a surface area of 2.32 cm² is applied to the top of the powder column and a voltage of 10V is applied across the column, following which the intensity is measured of the current that is allowed through. This determines the resistance of the column in the Ohmmeter.

### Preparation of Toner

### Example 1

Mixing of 88 parts by weight of a polyester resin (a reaction product of ethoxylated 2,2-bis(4-hydroxyphenyl)propane, a phthalic acid and adipine acid, acid value: 8 mg KOH/g, Tg: 57° C.) and 88 parts by weight of an epoxy polymer was carried out subsequently in a premixer and a melt kneading mixer. The epoxy polymer is a Epikote 828 derivative. The Epikote 828 resin has an epoxy group content of 5.32. To lower the Epoxygroup content of the resin, 80% of the free epoxygroups present was converted into an ether functional group by reacting the Epikote 828 resin with para-phenylphenol, yielding the Epikote 828 derivative as a resin having an Mn of 1100 g/mol and an Mw of 1400 g/mol and a Tg of 49° C. Then, 200 parts by weight of a magnetic pigment Bayoxide, an ironoxide (Fe₃O₄) which originates from LanXess (Germany), was added to the mixture, and was homogeneously mixed dispersed in the binder resins. Next, 24 part parts by weight of a high density oxidized polyethylene AC395a, which originates from Honeywell, was added to the mixture and was homogeneously dispersed in the binder resins.

The obtained mixture was then milled in a jet-mill, followed by classification to give toner particles having an volume median average particle size of 15 μm, which was distributed in such a way that at least 80% of the particles had a particle size in the range of 10 μm to 20 μm.

The surface of the toner was coated with carbon black (originating from Degussa—Germany) at a level of 1.6 parts carbon per 100 parts by weight toner particles. Further the surface of the toner was coated with a hydrophobic silica at a level of 0.3 parts silica per 100 parts toner particles. The electrical resistivity of the toner particles after the coating process was 1.0*10⁵ Ωm. The magnetisation of the toner particles was 30 mVs/ml.

The toner was tested in an Océ VP6000 toner imaging system at a long duration. After than 300 000 prints still no effects on the development performance was observed, indicating that the system has not been contaminated.

### Example 2-7

A toner was prepared according to example 1, the wax being an alternative oxidized polyethylene having a variation of acid value and viscosity at 140° C., as shown in Table 1. The high density oxidized polyethylene waxes AC 307a, AC 316, AC 330, AC 395a, Acumist A6 and Acumist A12 originate from Honeywell. The high density oxidized polyethylene wax Ceraflour 950 originates from Byk.

The amount of wax added to the toner composition was 6 wt % based on the total amount of weight of the toner. The Dynamic Coefficient of Friction was tested for a blank mixture without the addition of the magnetic pigment for example 1-7. A Dynamic Coefficient was further tested for a black mixture of a selection made out of these waxes (Example 1, 3, 6 and 7), whereby the magnetic pigment of Example 1 was added to the extrudate in an amount of 200 parts of magnetic pigment per 200 parts of binder resin. The Dynamic Coefficient of Friction of the black mixtures was similar to the corresponding blank mixtures. The dispersion of the wax in the binder resin was analysed using SEM pictures of the extrudated mixtures. All of these waxes provided a fine and homogeneous dispersion of the wax in the binder resin, in agreement with a diameter of less than about 2 μm.

TABLE 1
Example 1-7 of toners comprising a high-melting wax

| | | | | | Dispersion |
|---|---|---|---|---|---|
| | | | Viscosity | Dyn. CoF | wax in |
| Exam- | Ox. | Acid Value | (mPa · s) | (Blank | binder |
| ple | HDPE wax | (mg KOH/g) | 140° C. | Mixture) | resin |
| 1 | AC395a | 40 | 4187 | 0.24 | + |
| 2 | Acumist A12 | 30 | 3700 | 0.287 | + |
| 3 | AC330 | 30 | 4200 | 0.267 | + |
| 4 | Ceraflour | 30 | 4200 | 0.275 | + |
| | 950 | | | | |
| 5 | Acumist A6 | 30 | 4900 | 0.29 | + |
| 6 | AC316 | 16 | 11240 | 0.21 | + |
| 7 | AC307a | 7 | 80280 | 0.305 | + |

The melting transition of these waxes was measured using differential scanning calorimeter. All of these waxes have a melting transition which starts above 110° C., a melting peak in the range 129 to 133° C. and all of these waxes do not have a melting transition between room temperature and 110° C. In FIG. 2.1 and FIG. 3.1 the first heating scan is given for wax AC 330 and AC 316, showing the narrow melting range between 110° C. and 140° C. In case such a high melting wax is dispersed in the toner, the temperature range of wax melting transition has substantially not changed, and the lower limit temperature of the wax melting transition in the toner is also at least 110° C. or higher (FIGS. 2.2 and 3.2). In FIGS. 2.2 and 3.2 the glass transition temperature of the mixture of toner binders is also shown around 55° C. The toners according to example 2-7 were tested in a Océ VP6000 toner imaging system at a long duration. Contamination due to (partial) melting of the wax in the toner imaging system was not observed.

The weight average molecular weight Mw, number average molecular weight Mn and polydispersity D of several high-density oxidized polyethylene waxes having a melting peak in the range of 120° C.-135° C. is given in Table 1.2.

TABLE 1.2
Molecular weight Mw, Mn and polydispersity of narrow melting oxidized
polyethylene waxes according to the invention.

| | Mw | Mn | D |
|---|---|---|---|
| Ox. HDPE wax | [g/mol] | [g/mol] | [Mw/Mn] |
| AC 307 a | 19,400 | 9,300 | 2.1 |
| Acumist A12 | 11,000 | 3,600 | 3.0 |
| AC 330 | 8,800 | 2,600 | 3.3 |

The density and endothermic enthalpy of several high-density oxidized polyethylene waxes having a melting peak in the range of 120° C.-135° C. is given in Table 1.3.

TABLE 1.3
Density and endothermic enthalpy of narrow melting oxidized
polyethylene waxes according to the invention.

| | Density | Endothermic Enthalpy |
|---|---|---|
| Ox. HDPE wax | [g/ml] | [J/g] |
| AC 330 | 0.99 | 211 |
| AC 395a | 1.00 | 204 |
| AC 316 | 0.98 | 223 |
| AC 307 | 0.98 | 230 |

### Comparative Examples

As comparative examples several waxes were tested. Among them are oxidized polyethylene waxes.

### Comparative Example 1

A blank toner extrudate was made by mixing in a melt kneading mixer 94 parts by weight of a polyester resin (a reaction product of ethoxylated 2,2-bis(4-hydroxyphenyl)propane and phthalic acid, acid value: 8 mg KOH/g, Tg: 57° C.) and 94 parts by weight of an epoxy polymer were added and mixed. The epoxypolymer is a Epikote 828 derivative. The Epikote 828 resin has an epoxy group content of 5.32. To lower the Epoxygroup content of the resin, 80% of the free epoxygroups present was converted into an ether functional group by reacting the Epikote 828 resin with para-phenylphenol, yielding the Epikote 828 derivative as a resin having an Mn of 1100 g/mol and an Mw of 1400 g/mol and a Tg of 49° C. Next, 12 part parts by weight of a oxidized polyethylene Licowax PED 191 (Melting peak 124° C.), which originates from Clariant Corporation, was added to the mixture and was homogeneously dispersed in the binder resins.

### Comparative Example 2

A blank toner extrudate was made by mixing in a melt kneading mixer 94 parts by weight of a polyester resin (a reaction product of ethoxylated 2,2-bis(4-hydroxyphenyl)propane, a phthalic acid and adipine acid, acid value: 8 mg KOH/g, Tg: 57° C.) and 94 parts by weight of an epoxy polymer were added and mixed. The epoxypolymer is a Epikote 828 derivative. The Epikote 828 resin has an epoxy group content of 5.32. To lower the Epoxygroup content of the resin, 80% of the free epoxygroups present was converted into an ether functional group by reacting the Epikote 828 resin with para-phenylphenol, yielding the Epikote 828 derivative as a resin having an Mn of 1100 g/mol and an Mw of 1400 g/mol and a Tg of 49° C. Next, 12 part parts by weight of a oxidized polyethylene Licowax PED 192 (Melting peak 122° C.), which originates from Clariant Corporation, was added to the mixture and was homogeneously dispersed in the binder resins.

The Dynamic Coefficient of Friction was tested for a blank mixture without the addition of the magnetic pigment for Comparative example 1 and 2.

TABLE 2
Comparative toners

| | | | | | Dispersion |
|---|---|---|---|---|---|
| | | Viscosity | Melting | Dyn. CoF | wax in |
| Ox. | Acid Value | (mPa · s) | Peak | (Blank | binder |
| HDPE wax | (mg KOH/g) | 140° C. | (° C.) | Mixture) | resin |
| Licowax | 17 | 1560 | 124 | 0.270 | + |
| PED 191 | | | | | |
| Licowax | 22 | 1759 | 122 | 0.254 | + |
| PED 192 | | | | | |

The dispersion of the wax in the binder resin was analysed using SEM pictures of the extrudated mixtures. Both of these waxes provided a fine and homogeneous dispersion of the wax in the binder resin, in agreement with a diameter of less than about 2 μm. However both of the waxes have a melting range, which already starts below 110° C. In FIG. 4 the melting range of Licowax PED 191 is given. The waxes, although having a high temperature melting peak, are not usable as the lower limit of the melting range will provide a fast contamination of the printing system.

### Example 8-11 and Comparative Examples 3 and 4

The use of several toners was further tested in a particular printing system, VP6000, in a high-speed printing mode (250 pages per minute). An additional set of toners was prepared according to example 1. The type of wax was varied according to Table 3. The amount of wax added was 6 wt % based on the total weight of the toner. Example 8-11 are high-density oxidized polyethylene waxes. Comparative Example 3 and

Comparative Example 4 are both a high-density non oxidized wax polyethylene waxes having respectively a very high and very low viscosity. Both waxes have a melting peak, which starts below 110° C.

TABLE 3
Film forming behaviour of wax during high-speed printing after 32K
of long term printing.

| | | | | Dispersion | Filming |
|---|---|---|---|---|---|
| | | | | wax in | behaviour |
| | | Viscosity | Solid | extrudate* | on |
| | | (mPa · s at | behaviour | (size | Stripper |
| Example | Wax | 140 C.) | (RT) | domains) | element |
| 8 | AC330 | ~4000 | Brittle | Finely | No |
| 9 | AC325 | ~5000 | Brittle | Finely | No |
| 10 | AC316 | ~11000 | Brittle to | Medium/ | Slightly |
| | | | Tough | Finely | |
| 11 | AC307a | ~80000 | Tough | Medium | Much |
| Comparative | PE-wax | ~20000 | Tough | Medium | Much |
| Example 3 | | | | | |
| Comparative | PE-wax | ~50 | Brittle | Coarse | No |
| Example 4 | | | | | |

*finely dispersed: submicron - 2 μm's; Medium dispersed: ~2-5 μm; Coarse: >5 μm.

In high-speed development performance tests, performed at a speed of 250 pages a minute, it was observed that the film forming behaviour of the toner was first observed as a film-forming build up of toner on the stripper element of the developing means. The build-up of the toner on the stripper element of the developing means was analysed after a print system test of making 32.000 images.

The solid behaviour of the waxes was analysed by cutting a wax with a sharp knife. When during cutting film forming was observed, the wax is tough. When during cutting no film forming was observed, and the wax was partly broken during cutting, the wax is brittle. It is shown in Table 3, that a toner according to the present invention shows more filming behaviour in the particular printing system, in case the viscosity of the wax at 140° C. is higher than 10 Pa·s and the solid wax has tough cutting behaviour.

### Examples 12-14

The effect of the melt kneading process on the dispersion quality of the wax was tested for wax AC-330. Into a melt kneading mixer originating from Berstorff 52 parts by weight of a polyester resin (a reaction product of ethoxylated 2,2-bis(4-hydroxyphenyl)propane and phthalic acid, acid value: 8 mg KOH/g, Tg: 57° C.) and 43 parts by weight of an epoxy polymer were added. The epoxypolymer is a Epikote 828 derivative. The Epikote 828 resin has an epoxy group content of 5.32. To lower the Epoxygroup content of the resin, 80% of the free epoxygroups present was converted into an ether functional group by reacting the Epikote 828 resin with para-phenylphenol, yielding the Epikote 828 derivative as a resin having an Mn of 1100 g/mol and an Mw of 1400 g/mol and a Tg of 49° C. Next, 6 part parts by weight of a high density oxidized polyethylene AC-330, which originates from Honeywell, was added to the mixture. The composition was mixed in the melt kneading mixer according to the temperature ranges given in Table 4.

TABLE 4
effect of the melt kneading process on the dispersion quality of the
wax AC-330

| | | | Dispersion wax in |
|---|---|---|---|
| | T start | T end | extrudate* (size |
| Example | [° C.] | [° C.] | domains) |
| 12 | 80 | 130 | Very fine |
| 13 | 130 | 130 | Rough |
| 14 | 95 | 95 | Very rough |

The loss compliance (J″) of the blank toner extrudates was measured. In FIG. 7 the loss compliance of the examples 12-14 is shown. The dispersion quality of the wax was analysed using SEM and light-microscopy. It was found, that the blank toner extrudate of Example 12 both had a very fine dispersion of the wax (sub-micron domains) and provided a minimum peak in the loss compliance in the range between 110° C. and 130° C.

### Comparative Examples 5-9

As comparative examples several non-oxidized high-melting polyethylene waxes were tested. All of the waxes have a melting peak in the range of 110° C. to 140° C. A blank toner extrudate was made by mixing in a melt kneading mixer 94 parts by weight of a polyester resin (a reaction product of ethoxylated 2,2-bis(4-hydroxyphenyl)propane, a phthalic acid and adipic acid, acid value: 8 mg KOH/g, Tg: 57° C.) and 94 parts of an epoxy polymer were added and mixed. The epoxypolymer is a Epikote 828 derivative. The Epikote 828 resin has an epoxy group content of 5.32. To lower the Epoxygroup content of the resin, 80% of the free epoxygroups present was converted into an ether functional group by reacting the Epikote 828 resin with para-phenylphenol, yielding the Epikote 828 derivative as a resin having an Mn of 1100 g/mol and an Mw of 1400 g/mol and a Tg of 49° C. Next, 12 part parts by weight of a wax of Table 4 was added to the mixture and was dispersed in the binder resins in a melt kneading process. The Dynamic Coefficient of Friction and the dispersion of the wax in the binder resin was analysed for a blank mixture (without the addition of the magnetic pigment).

TABLE 5
comparative examples of non-oxidized high-melting polyethylene and
polypropylene waxes.

| | | | | | Dispersion |
|---|---|---|---|---|---|
| | Non-ox. | Viscosity | Melting | Dyn. CoF | wax in |
| Comparative | (HD)PE | (mPa · s) | Peak | (Blank | binder |
| Examples | wassen | 140° C. | (° C.) | Mixture) | resin |
| CE 5 | Viscol | 75 | 143 | not tested | −/+ |
| | 660P* | | | | |
| CE 6 | PW 1000 | 13 | 113 | 0.236 | − |
| CE 7 | Acumist B6 | 90 | 124 | 0.25 | − |
| CE 8 | Licowax | 314 | 127 | 0.288 | − |
| | PE 130 | | | | |
| CE 9 | Sunflower | 5 | 80 | 0.372 | − |
| | esterwax | | | | |

*Viscol 660P was tested at 2.5 wt % using an additional 1.5 wt % of Li-stearate

The Dynamic Coefficient of Friction is about 0.30 or lower. However the domains of the dispersion of the wax for CE 6-CE 9 are (much) bigger than about 2 μm. Li-stearate was added to Viscol 660P in order to better disperse the wax in the binder resin. The domains of the dispersion of the Viscol 660 P were in the range 3-5 μm.

All of the waxes have a melting transition which starts below 110° C. The Viscol 660P has a very broad melting transition starting far below 110° C. and extending up to above 140° C. The melting transition of Polywax 1000 is shown in FIG. 6.

Contamination of the Océ printing system VP6000 was tested for the comparative toners 5, 6 and 9. The contamination of the Océ VP6000 printing system was observed for the toner comprising the high-melting polypropylene wax Viscol 660P. It was found that already after 15.000 images contamination occurred in the printing system by the wax thereby disturbing the developing performance of the toner.

The contamination of the Océ VP6000 printing system disturbing the developing performance was already observed for the toner comprising Polywax 1000 after printing 1.000 images. The contamination of the Océ VP6000 printing system disturbing the developing performance was observed for the toner comprising Sunflower wax after printing 100 to 350 images.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

1. A toner for developing a toner image, the toner comprising:
(i) a binder resin;
(ii) an inorganic component, preferably a magnetic component; and
(iii) a wax, the wax being an oxidized polyalkylene wax, the wax being finely dispersed in the binder resin, said wax having a wax melting transition, wherein the lower temperature limit of said wax melting transition is between 110° C. and 140° C. at a time of temperature rise in a DSC thermogram measured using a differential scanning calorimeter.

2. The toner according to claim 1, wherein said wax melting transition has an upper temperature limit of at most 140° C. at the time of temperature rise in the DSC thermogram measured using a differential scanning calorimeter.

3. The toner according to any of the previous claims, wherein the viscosity of the wax is in the range 1 Pa·s to 10 Pa·s at 140° C.

4. The toner according to any of the previous claims, wherein the wax is a oxidized polyethylene wax having a melting peak in a temperature range of 120° C. to 135° C. at the time of temperature rise in the DSC thermogram measured using a differential scanning calorimeter, said wax having a polydispersity D of less than about 3.5.

5. The toner according to any of the previous claims, wherein the wax has an acid value from 5 mg KOH/g to 50 mg KOH/g.

6. The toner according to any of the previous claims, wherein the binder resin has an acid value from 5 mg KOH/g to 30 mg KOH/g.

7. The toner according to any of the previous claims, wherein a dispersion of the wax in the binder resin has a number average diameter in the range of 0.2 μm to 3 μm.

8. The toner according to any of the previous claims, wherein the wax has in said melting transition range an endothermic enthalpy of at least 200 J/g at the time of temperature rise in the DSC thermogram measured using a differential scanning calorimeter.

9. The toner according to any of the previous claims, the inorganic component comprising a magnetic component, the amount of wax is from 1 wt % to 10 wt % based on the total weight of the toner and the amount of the magnetic component is from 30 wt % to 70 wt % based on the total weight of the toner, preferably the amount of magnetic component is from 40 wt % to 60 wt % based on the total weight of the toner.

10. A printing system for applying a toner on an image receiving medium, the toner comprising:
(i) a binder resin,
(ii) an inorganic component, preferably a magnetic component; and
(iii) a wax, the wax being an oxidized polyalkylene wax, the wax being finely dispersed in the binder resin, the wax having a wax melting transition in a temperature range of 110° C. to 140° C. at the time of temperature rise in the DSC thermogram measured using a differential scanning calorimeter, wherein the lower temperature limit of said wax melting transition is at least 110° C. or higher,
the printing system comprising:
(A) a developing means configured for in operation developing a toner image,
(B) an intermediate image bearing means configured for in operation transferring the toner from the developing means to the intermediate image bearing means in a first transfer zone and for transferring the toner from the intermediate image bearing means to an image receiving medium in a second transfer zone.

11. The printing system according to claim 10, wherein the transfer in the second transfer zone is carried out in a temperature range from 80° C. to 110° C.

12. The printing system according to claim 10 or 11, the printing system further comprising:
(C) a fixing means configured for in operation fixing the toner onto an image receiving medium by applying a fixing pressure and a fixing temperature, preferably said fixing temperature being in the range of 120° C. to 180° C.

13. A method for producing a toner comprising the steps:
(i) selecting a binder resin,
(ii) selecting an inorganic component, preferably a magnetic component,
(iii) selecting a wax, the wax being an oxidized polyalkylene wax, the wax having a wax melting transition in a temperature range of 110° C. to 140° C. at the time of temperature rise in the DSC thermogram measured using a differential scanning calorimeter, wherein the lower temperature limit of said wax melting transition is at least 110° C. or higher
(iv) mixing the magnetic component and the binder resin in a melt kneading process at a temperature above 80° C., such that the magnetic component is dispersed in the binder resin, said magnetic component dispersion having a number average diameter of less than 5 μm, more preferably less than 2 μm
(v) mixing the wax and the binder resin in a melt kneading process in a melt temperature range between 110° C. to 140° C., such that the wax is finely dispersed in the binder resin.

14. The method for producing the toner according to claim 13, wherein step (v) mixing the wax in the binder resin is carried out after the magnetic component has been mixed with the binder resin in step (iv).

15. The method for producing the toner according to claim 13 or 14, wherein step (iv) the mixing of the magnetic component and the binder resin is carried out at a lower temperature than step (v) the mixing of the wax with the binder resin.
